(19) United States
(12) Patent Application Publication
(10) Pub. No.: US 2012/0075209 A1
(43) Pub. Date: Mar. 29, 2012

(54) TOUCH PANEL

(75) Inventors: CHIEN-WEI LEE, Hsinchu City (TW); YAN-WEI CHEN, TAIPEI COUNTY (TW); CHIH-LUNG LIN, TAINAN CITY (TW)

(73) Assignee: CATCHER TECHNOLOGY CO., LTD., Tainan (TW)

(21) Appl. No.: 13/051,799

(22) Filed: Mar. 18, 2011

(30) Foreign Application Priority Data
Sep. 29, 2010 (TW) 099133174

(51) Int. Cl. G06F 3/041

(52) U.S. Cl. 345/173

(57) ABSTRACT

A touch panel, which contains a substrate, a mask layer, a sensing circuit layer and a barrier layer, is disclosed. The mask layer is disposed around the bottom surface of the substrate. The sensing circuit layer is located on the same side of the substrate with the mask layer, and the surrounding area of the sensing circuit layer is shielded by the mask layer. In addition, the area of the sensing circuit layer exposed from the mask layer is defined as a sensing region. Furthermore, the barrier layer is disposed between the substrate and the sensing circuit layer and between the mask layer and the sensing circuit layer. Concurrently, the barrier layer further provides separation between the mask layer and the sensing circuit layer. The barrier layer has a transparent appearance. Particularly, the barrier layer is provided for changing optical refraction and harmonizing optical reflection index and transmittance.

### FIELD OF THE INVENTION

The present invention relates to a touch panel, and more particularly to a touch panel which comprises a barrier layer disposed between the mask layer and the sensing circuit layer.

### BACKGROUND OF THE INVENTION

Currently, the touch panel has been quite popular in use, and it is quite convenient for the users to proceed the inputs or other operations by merely click the figures and texts shown in the panel with their fingers or pen-like objects.

However, the manufacturing process of the touch panel and the display panel that have multi assemblies therebetween will consume more raw materials; furthermore, the practice manufacturing procedure of the touch panel comprises the steps of accomplishing the process of forming each individual structure layer first, and then integrating all of these individual layers into an unity. As a result, the defective products may occur easily due to the foregoing complicated assembly procedure. In addition, the thickness of the touch panel may be thus increased because of overlapping of these layers. As a result, it is very difficult to produce thinner electronic products.

### SUMMARY OF THE INVENTION

A primary objective of the present invention is to provide a touch panel, and the touch panel is characterized by a barrier layer disposed between the mask layer and the sensing circuit layer so as to improve the problems existed in the aforesaid prior art.

To achieve the above and other objectives, the touch panel according to the present invention comprises a substrate, a mask layer, a sensing circuit layer and a barrier layer. The substrate has a top surface and a bottom surface. The mask layer is disposed around the bottom surface of the substrate, and the mask layer is provided for shielding the metal trace of the sensing circuit layer. In addition, the sensing circuit layer is disposed on the substrate and the sensing circuit layer is located on the same side of the substrate as the mask layer, such that a surrounding area of the sensing circuit layer is shielded by the mask layer. Except for the area shielded by the mask layer, the sensing circuit layer further exposes externally a sensing area. Furthermore, the present invention discloses that a barrier layer is disposed between the bottom surface of the substrate and the sensing circuit layer and between the mask layer and the sensing circuit layer, so as to integrate the substrate, the mask layer and the sensing circuit layer with one another. As a result, the barrier layer according to the present invention provides separation and insulation between the substrate and the sensing circuit layer and between the mask layer and the sensing circuit layer.

Accordingly, the substrate is formed of a transparent insulation material or a flexible transparent insulation material, which is selected from a group consisting of glass, acrylic, polycarbonate, polyester, poly methyl acrylate, cyclic olefin copolymers and polyether sulfone. Moreover, t the mask layer is formed of a material selected from a group consisting of chromium, chromium oxide, chromium nitride, chromium carbide, graphite, dispersed-type black matrix resin and commercial black resin coating material.

The aforesaid barrier layer is composed of silicon oxide, titanium oxide or other inorganic or organic materials with similar properties, and the appearance of the barrier layer is semi-transparent or transparent. In addition, the barrier layer is a refraction-changing layer or a reflection index and transmittance-harmonizing layer. Generally, the barrier layer is formed of a material selected from a group consisting of silicon oxide, titanium oxide, alumina, zirconia, chromium oxide, yttrium oxide, hafnium oxide, niobium oxide, barium titanate, strontium titanate, silicon nitride, silicon oxynitride, sialon, polyether ether ketone, epoxy resin, acrylic, polyimide, polysulfone, polyether sulfone, poly aryl sulfone, aromatic polyamide, and polyester. And the barrier layer is a layer that improves adhesiveness and etching property of the sensing circuit layer.

Moreover, the sensing circuit layer comprises at least one electrode and at least one metal trace. Particularly, the electrode is composed of semi-transparent or transparent conductive material, and the electrode is formed of a material selected from a group consisting of indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene). In addition, the metal trace is formed of a material selected from a group consisting of gold, silver, copper, aluminum, chromium, molybdenum/aluminum/molybdenum layered metal, graphite, aluminum indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene).

Furthermore, the present invention further comprises a protection layer which is formed on a bottom surface of the sensing circuit layer, and an adhesion layer is formed on a bottom surface of the protection layer thereafter. Subsequently, the adhesion layer is adhered to a display panel module by means of a peripheral spreading method or an overall spreading method. Consequently, the protection layer is composed of a flexible film, an electric-field shielding film, a silicon oxide or a commercial photo-resist. The protection layer is a layer that enhances strength of the substrate, excludes noise signal or adjusts reflection index and transmittance of the substrate.

Accordingly, the touch panel of the present invention has one or more advantages as following:

(1) The touch panel according to the present invention is much thinner than conventional touch panel.

(2) The barrier layer according to the present invention is a refraction-changing layer or a reflection index and transmittance-harmonizing layer.

(3) The barrier layer according to the present invention provides separation and insulation between the mask layer and the sensing circuit layer.

(4) The barrier layer according to the present invention can improve adhesiveness and etching property of the sensing circuit layer.

(5) The barrier layer according to the present invention is able to protect the mask layer.

### BRIEF DESCRIPTION OF THE DRAWINGS

The structure and the technical means adopted by the present invention to achieve the above and other objectives can be best understood by referring to the following detailed description of the preferred embodiments and the accompanying drawings.

FIG. 1 is a cross-sectional schematic diagram showing a touch panel according to a first preferred embodiment of the present invention.

FIG. 2 is a cross-sectional schematic diagram showing a touch panel according to a second preferred embodiment of the present invention.

### DETAILED DESCRIPTION OF THE PREFERRED EMBODIMENTS

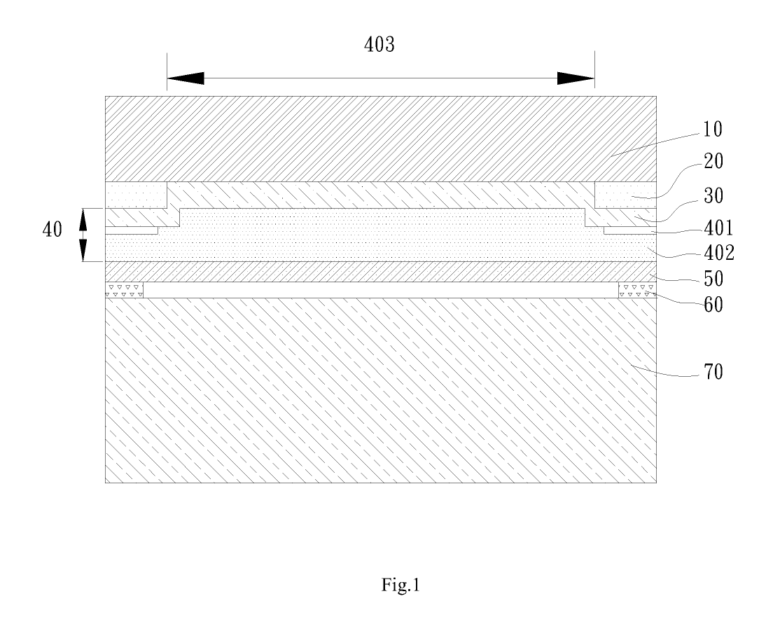

Please refer to FIG. 1 which is a cross-sectional schematic diagram showing a touch panel according to a first preferred embodiment of the present invention. As shown in FIG. 1, the touch panel comprises a substrate 10, a mask layer 20, a sensing circuit layer 40 and a barrier layer 30. The substrate 10 could be glass, which has a top surface and a bottom surface. The mask layer 20 is disposed around the bottom surface of the substrate 10, and the mask layer 20 is black matrix or other coating layer with shielding effect, such as metallic layer or organic layer. In addition, the sensing circuit layer 40 is disposed on the substrate 10 and the sensing circuit layer 40 is located on the same side of the substrate as the mask layer 20, such that a surrounding area of the sensing circuit layer 40 is shielded by the mask layer 20. Except for the area shielding by the mask layer 20, the sensing circuit layer 40 further exposes externally a sensing area 403. Furthermore, the present invention discloses that a barrier layer 30 is disposed between the bottom surface of the substrate 10 and the sensing circuit layer 40 and between the mask layer 20 and the sensing circuit layer 40, so as to integrate the substrate 10, the mask layer 20 and the sensing circuit layer 40 with one another. As a result, the barrier layer 30 according to the present invention provides separation and insulation between the substrate 10 and the sensing circuit layer 40 and between the mask layer 20 and the sensing circuit layer 40.

Accordingly, the substrate 10 is formed of a transparent insulation material or a flexible transparent insulation material, which is selected from a group consisting of glass, acrylic, polycarbonate, polyester, poly methyl acrylate, cyclic olefin copolymers and polyether sulfone. Moreover, the mask layer is formed of a material selected from a group consisting of chromium, chromium oxide, chromium nitride, chromium carbide, graphite, dispersed-type black matrix resin and commercial black resin coating material.

However, the aforesaid barrier layer 30 is composed of silicon oxide, titanium oxide or other inorganic or organic materials with similar properties, and the appearance of the barrier layer 30 is semi-transparent or transparent. In addition, the barrier layer 30 is a refraction-changing layer or a reflection index and transmittance-harmonizing layer. Generally, the barrier layer 30 is formed of a material selected from a group consisting of silicon oxide, titanium oxide, alumina, zirconia, chromium oxide, yttrium oxide, hafnium oxide, niobium oxide, barium titanate, strontium titanate, silicon nitride, silicon oxynitride, sialon, polyether ether ketone, epoxy resin, acrylic, polyimide, polysulfone, polyether sulfone, poly aryl sulfone, aromatic polyamide, and polyester. Therefore, the barrier layer 30 not only provides separation and insulation between the mask layer 20 and the sensing circuit layer 40, and it also has advantages of changing optical refraction and harmonizing optical reflection index and transporting rate. And the barrier layer 30 is a layer that improves adhesiveness and etching property of the sensing circuit layer 40.

To be emphasized, the sensing circuit layer 40 is manufactured by typical coating, exposure, developing and etching method, and the sensing circuit layer 40 comprises at least one electrode 402 and at least one metal trace 401. According to the FIG. 1, the metal trace 401 could be established around the upper side of the electrode 402. Therefore, the mask layer 20 could shield the metal trace 401 to prevent the metal trace 401 from exposing outside the appearance of the substrate 10, such that the appearance of the substrate 10 could be purified. Particularly, the electrode 402 is composed of semi-transparent or transparent conductive material, and the electrode 402 is formed of a material selected from a group consisting of indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene). In addition, the metal trace 401 is formed of a material selected from a group consisting of gold, silver, copper, aluminum, chromium, molybdenum/aluminum/molybdenum layered metal, graphite, aluminum indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene).

Furthermore, the present invention further comprises an protection layer 50 which formed on a bottom surface of the sensing circuit layer 40, and an adhesion layer 60 is formed on bottom surface of the protection layer 50 in sequence (The adhesion layer 60 also has possibilities to couple with the protection layer 50 directly). Subsequently, the adhesion layer 60 adhered to a display panel module 70 by means of a peripheral spreading method or an overall spreading method. The display panel module 70 further comprises an upper polarizer to glue to the adhesion layer 60 directly. Consequently, the protection layer 50 is composed of a flexible film, an electric-field shielding film, a silicon oxide or a commercial photo-resist. The protection layer 50 is a layer that enhances strength of the substrate 10, excludes noise signal or adjusts reflection index and transmittance of the substrate 10.

Conclusively, the aforementioned display panel module 70 could display figures or texts on the substrate 10 via the sensing circuit layer 40 and the barrier layer 30. Especially, when a user touches the top surface of the substrate 10 with his/her fingers, the electrode 402, within the sensing area 30 of the sensing circuit layer 40, produces a capacitance effect by transferring the touch motion corresponding to the touched position. Moreover, the capacitance effect consecutively generates a sensing signal. Therefore, the sensing signal would be output to an external CPU via the metal trace 401 to proceed with estimation of the actual sensing position, so that the purpose of touch-to-control will be achieved.

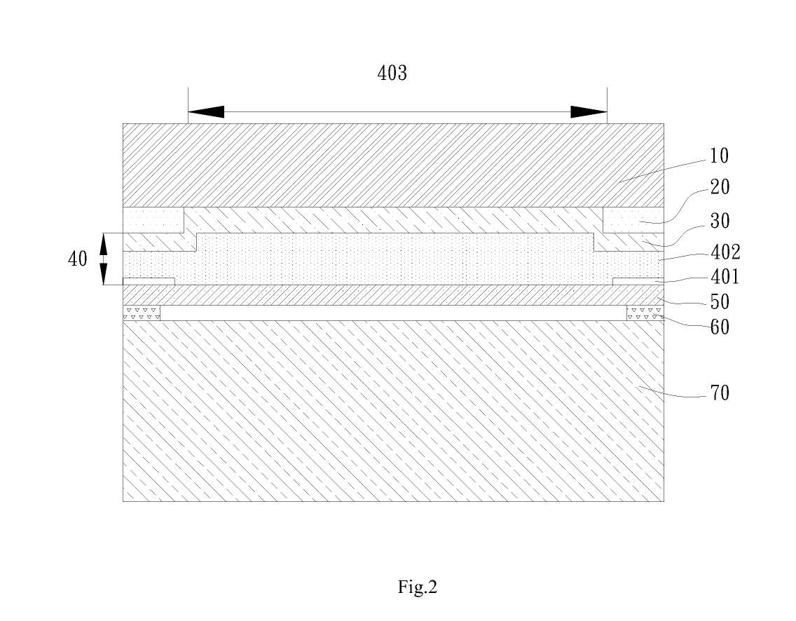

Please refer to FIG. 2 which is a cross-sectional schematic diagram showing a touch panel according to a second preferred embodiment of the present invention. As shown in FIG. 2, the metal trace 401 is established around the bottom side of the electrode 402, which is the only one different feature compared to the first preferred embodiment shown in FIG. 1. The descriptions set forth hereinbefore are simply exemplary rather than restrictive. All effectively equivalent modifications, changes or alternations made thereto without departing from the spirit and scope of the present invention are deemed as being encompassed by the field of the present invention defined as the following claims.

What is claimed is:

1. A touch panel, comprising:
a substrate having a top surface and a bottom surface;
a mask layer disposed around said bottom surface of said substrate;
a sensing circuit layer disposed on said substrate and said sensing circuit layer located on the same side of said substrate as said mask layer, such that a surrounding area of said sensing circuit layer is shielded by said mask layer; and
a barrier layer disposed between said bottom surface of said substrate and said sensing circuit layer and between said mask layer and said sensing circuit layer so as to integrate said substrate, said mask layer and said sensing circuit layer with one another, wherein said barrier layer provides separation and insulation between said substrate and said sensing circuit layer and between said mask layer and said sensing circuit layer.

2. The touch panel as claimed in claim 1, wherein said substrate is formed of a transparent insulation material or a flexible transparent insulation material selected from a group consisting of glass, acrylic, polycarbonate, polyester, poly methyl acrylate, cyclic olefin copolymers and polyether sulfone.

3. The touch panel as claimed in claim 1, wherein said mask layer is formed of a material selected from a group consisting of chromium, chromium oxide, chromium nitride, chromium carbide, graphite, dispersed-type black matrix resin and commercial black resin coating material.

4. The touch panel as claimed in claim 1, wherein said barrier layer is formed of a material selected from a group consisting of silicon oxide, titanium oxide, alumina, zirconia, chromium oxide, yttrium oxide, hafnium oxide, niobium oxide, barium titanate, strontium titanate, silicon nitride, silicon oxynitride, sialon, polyether ether ketone, epoxy resin, acrylic, polyimide, polysulfone, polyether sulfone, poly aryl sulfone, aromatic polyamide, and polyester.

5. The touch panel as claimed in claim 1, wherein said sensing circuit layer further comprises at least one electrode and at least one metal trace.

6. The touch panel as claimed in claim 5, wherein said electrode is formed of a material selected from a group consisting of indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene).

7. The touch panel as claimed in claim 5, wherein said metal trace is formed of a material selected from a group consisting of gold, silver, copper, aluminum, chromium, molybdenum/aluminum/molybdenum layered metal, graphite, aluminum indium tin oxide, indium zinc oxide, antimony tin oxide, aluminum oxide zinc, zinc oxide, tin oxide, carbon nanotubes, metallic silver film, copper film, poly thiophene, polyacetylene, polyaniline, polyimide polymer pyrrole and poly (3,4-ethylenedioxythiophene).

8. The touch panel as claimed in claim 1, further comprising a protection layer formed on a bottom surface of said sensing circuit layer.

9. The touch panel as claimed in claim 8, wherein said protection layer is composed of a flexible film, an electric-field shielding film, a silicon oxide or a commercial photo-resist.

10. The touch panel as claimed in claim 8, wherein said protection layer is a layer that enhances strength of said substrate, excludes noise signal and adjusts reflection index and transmittance of said substrate.

11. The touch panel as claimed in claim 8, further comprising an adhesion layer formed on a bottom surface of said protection layer, wherein said adhesion layer adhered to a display panel module by means of a peripheral spreading method or an overall spreading method.

12. The touch panel as claimed in claim 1, wherein said barrier layer is a refraction-changing layer or a reflection index and transmittance-harmonizing layer.

13. The touch panel as claimed in claim 1, wherein said barrier layer is a layer that improves adhesiveness and etching property of said sensing circuit layer.

14. The touch panel as claimed in claim 1, wherein said barrier layer is semi-transparent or transparent.

15. The touch panel as claimed in claim 1, wherein said barrier layer is an electrical insulation layer.
